(19) United States
(12) Patent Application Publication
(10) Pub. No.: US 2014/0001786 A1
(43) Pub. Date: Jan. 2, 2014

(54) FOLDABLE FLOOR ASSEMBLY FOR AN EXPANDABLE SHELTER

(71) Applicants: Philp T. Cantin, Guildhall, VT (US); Justin M. White, West Danville, VT (US)

(72) Inventors: Philp T. Cantin, Guildhall, VT (US); Justin M. White, West Danville, VT (US)

(21) Appl. No.: 13/932,515

(22) Filed: Jul. 1, 2013

Related U.S. Application Data
(60) Provisional application No. 61/666,272, filed on Jun. 29, 2012.

(51) Int. Cl. B60P 3/34

(52) U.S. Cl. CPC B60P 3/341
USPC 296/26.14

(57) ABSTRACT

A foldable floor assembly, including an outboard floor panel apparatus including a bottom surface and a top usable surface generally extending in a floor plane and configured to be used when the foldable floor assembly is in an unfolded state and a pivot rail having an inboard surface, the pivot rail movable in a horizontal direction substantially parallel to the floor plane, wherein movement of the inboard surface of the pivot rail in the horizontal direction toward the outboard floor panel apparatus imparts a moment onto the outboard floor panel apparatus when the bottom surface of the outboard floor panel apparatus and the inboard surface of the pivot rail are in contact with one another.

### CROSS-REFERENCE TO RELATED APPLICATIONS

This application claims priority from U.S. Patent Application No. 61/666,272, filed on Jun. 29, 2012.

### BACKGROUND

1. Field

The present application relates generally to an expandable shelter system, and more particularly, to a foldable floor for an expandable shelter system.

2. Related Art

Portable shelters are often used to provide temporary facilities for various purposes, such as military, civilian, and medical applications. Such portable shelters may be used to supplement permanent structures when additional space is desired, or to provide new facilities for temporary use, such as the provision of emergency response services after a disaster. Motorized vehicles, such as vans, buses, and recreational vehicles (RVs), etc., may be used as portable shelters under certain circumstances. While these types of motorized vehicles are able to transport themselves to a desired location, they typically provide limited interior space for the intended use, while also being relatively expensive. Some portable shelters are configured to have the size and shape of a standard International Organization for Standardization (ISO) intermodal shipping container. In this way, such shelters may be shipped by commercial means, such as by railway, boat, or aircraft, including military aircraft.

The floor space of conventional portable shelters is limited by the fixed external dimensions of the shelter. Expansion modules akin to “slide out” sections of RVs have been used to increase the operational floor space enclosed by a shelter. Such modules, also known as “expandable components,” may be hydraulically or mechanically extended and retracted from the shelter on support beams.

### SUMMARY

Embodiments of the disclosed technology include a foldable floor assembly, comprising an outboard floor panel apparatus including a bottom surface and a top usable surface generally extending in a floor plane and configured to be used when the foldable floor assembly is in an unfolded state, and a pivot rail having an inboard surface, the pivot rail movable in a horizontal direction substantially parallel to the floor plane, wherein movement of the inboard surface of the pivot rail in the horizontal direction toward the outboard floor panel apparatus imparts a moment onto the outboard floor panel apparatus when the bottom surface of the outboard floor panel apparatus and the inboard surface of the pivot rail are in contact with one another.

Embodiments of the disclosed technology also include a method of folding a foldable floor, comprising obtaining a planar outboard floor panel usable surface and a planar inboard floor panel usable surface that generally lie on the same floor plane as one another and applying a force in a direction at least about parallel to the floor plane, thereby moving the outboard floor panel usable surface and the inboard floor panel usable surface out of the floor plane and to a non-zero angle relative to the floor plane.

Embodiments of the disclosed technology also include a foldable floor assembly, comprising an outboard floor panel, and an inboard floor panel, wherein the inboard floor panel is hingedly linked to the outboard floor panel, and a means for at least commencing folding of the outboard floor panel and the inboard floor panel together.

### BRIEF DESCRIPTION OF THE DRAWINGS

Embodiments of the disclosed technology are described below with reference to the attached drawings, in which:

FIGS. 1A and 1B illustrate an exemplary embodiment in which the technology has utility in the form of a shelter configured as a fifth wheel trailer;

FIG. 1C illustrates an exemplary embodiment in which the technology has utility in the form of a shelter based on an International Organization for Standardization (ISO) intermodal shipping container.

FIGS. 2A-2F are functional schematics depicting folding of a floor assembly according to an exemplary embodiment;

FIG. 3 is a perspective view of a portion of a sub-shelter assembly according to an exemplary embodiment;

FIG. 4 is side view of a portion of the view of FIG. 3;

FIG. 5 is a side view of an embodiment generally corresponding to the embodiment of FIG. 3;

FIG. 6 is another side view of an embodiment generally corresponding to the embodiment of FIG. 3;

FIG. 7 is a close up view of FIG. 6 that provides details associated with operation of the embodiment of FIG. 6;

FIG. 8 provides details associated with operation of the embodiment of FIG. 6;

FIG. 9 is a close-up view of a portion of FIG. 8;

FIG. 10 provides details associated with operation of the embodiment of FIG. 6 in an exemplary fully folded upright position;

FIG. 11 is a close-up view of a portion of FIG. 10;

FIG. 12A is a functional schematics depicting a phenomenon associated with an exemplary floor assembly;

FIG. 12B is a functional schematic depicting an phenomenon that is avoided in at least some embodiments of the present technology;

FIGS. 13A-13C are schematics of components used in the embodiment of FIG. 6;

FIGS. 14A-14D are schematics of components used in the embodiment of FIG. 6;

FIGS. 15A-17 are schematics depicting operation of the embodiment of FIG. 6; and

FIG. 18 is an exemplary flowchart presenting a method associated with use of the embodiment of FIG. 6.

### DETAILED DESCRIPTION

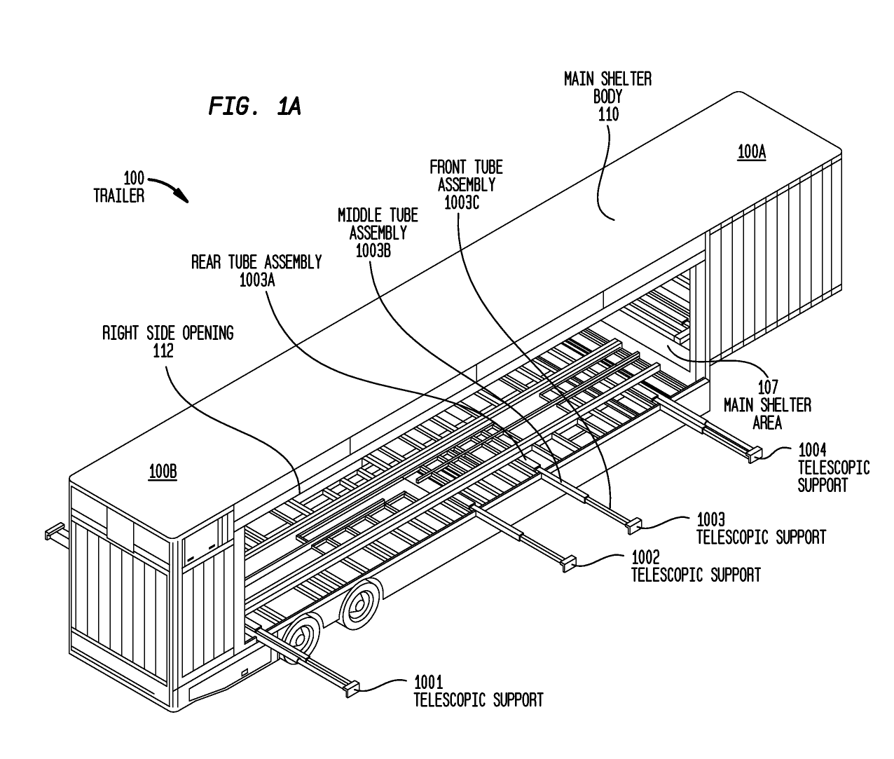

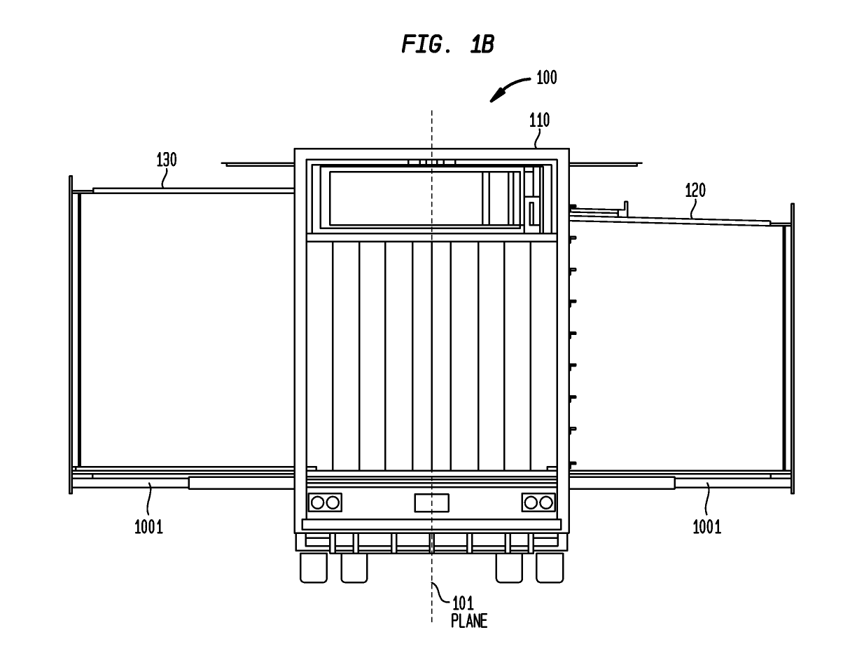

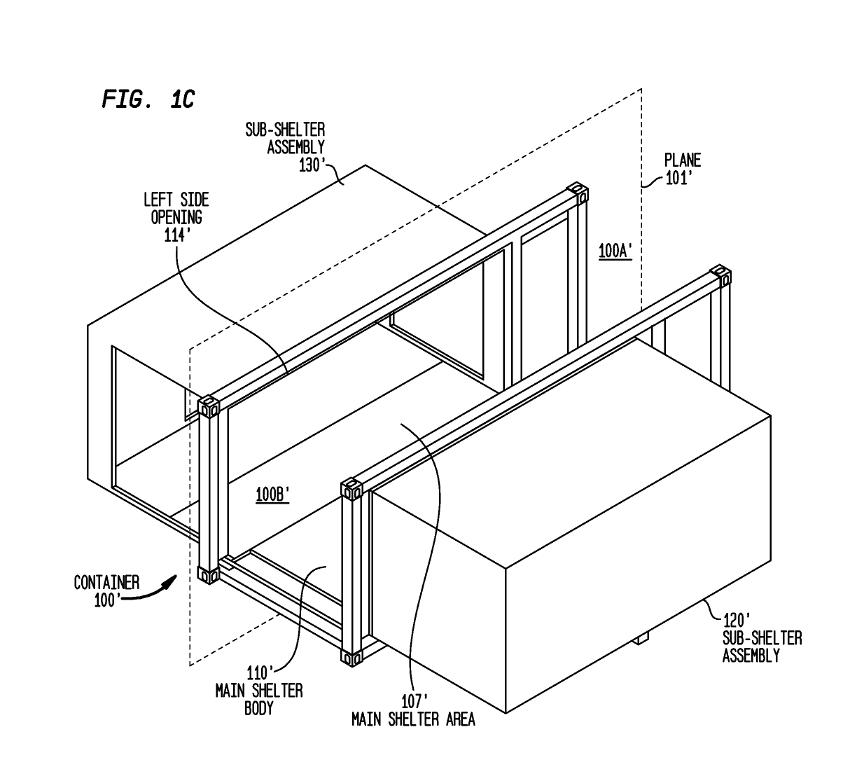

As noted above, embodiments of the technology disclosed herein have utility in shelters, including mobile shelters, having an expandable component. FIG. 1A depicts a portion of an exemplary fifth wheel trailer 100 that is part of a mobile shelter that includes structure generally forming a main shelter body 110 and includes components typically found in such a trailer including a chassis, body panels, signaling, braking, control and communication components. FIG. 1B depicts a rear view of the trailer 100. FIG. 1B further depicts sub-shelter assemblies 120 and 130 (which are not shown in FIG. 1A for purposes of clarity). As will be described in greater detail below, the sub-shelter assemblies 120 and 130 extend and retract in a direction normal to the longitudinal vertical plane 101 of the trailer 100.

The main shelter body 110 is characterized by a main shelter area 107 including a right side opening 112 and left side opening (not labeled) through which sub-shelter assemblies 120 and 130 extend/retract, respectively. This provides, in at least some embodiments, an “enclosed space multiplier” effect in that available enclosed space for the shelter can be quickly expanded from that which might be provided by the trailer 100 without these sub-shelter assemblies.

As may be seen, sub-shelter assemblies 120 and 130 each generally form volumes in the form of rectangular boxes, although in other embodiments, other shaped volumes may be utilized (e.g., the roofs may be sloped away from the main shelter body 110′, the volumes may be square boxes, etc.). These sub-shelter assemblies have outer boundaries (e.g., walls, doors, etc.) which, along with the main shelter body 110, establish the boundaries of the shelter.

By way of example only and not by way of limitation, the trailer 100 includes a plurality of telescopic support assemblies 1001-1004. The right side opening 112 has associated therewith four (4) telescopic supports, 1001-1004, and the second opening likewise has such supports associated therewith, the rearmost of which can be partially seen in FIG. 1A. Each telescopic support is shown in an extended configuration. Telescopic supports 1001 and 1004, are powered telescopic supports (one or both of which may be unpowered in some embodiments) including a drive assembly such as a hydraulic cylinder subassembly configured to extend and retract the telescopic support. Telescopic supports 1002 and 1003 are not powered in some embodiments (and one or both may be powered in other embodiments, and in other embodiments, none may be powered), and are extended and retracted as a result of being mechanically linked to telescopic supports 1001 and 1004 (e.g., by being attached to a common structure, such as sub-shelter assembly 120, and, accordingly, the telescopic supports move in unison).

Telescopic supports 1001-1004 are shown as three-part tube assemblies, as illustrated with respect to tube assembly 1003. Tube assembly 1003 comprises rear tube assembly 1003A, a middle tube assembly 1003B, and front tube assembly 1003C. The “C” elements of the tubes extend out of/retract into the “B” elements of the tubes, and the “B” elements of the tubes extend out of/retract into the “A” elements of the tubes during extension/retraction of the sub-shelter assemblies 120 and 130. Because the ends of the telescopic supports 1001-1004 travel with mating components of the sub-shelters, the sub-shelters are supported against the direction of gravity generally at their outboard portions by the telescopic supports 1001-1004.

FIG. 1C depicts a portion of an exemplary expandable shelter in the form of a container 100′ having the size and shape corresponding to that of a standard ISO container with which the teachings detailed herein and/or variations thereof may be utilized. FIG. 1C depicts sub-shelter assemblies 120′ and 130′ which expand from a main shelter body 110′ of the container 100′. As will be described in greater detail below, the sub-shelter assemblies 120′ and 130′ extend and retract in a direction normal to the longitudinal vertical plane 101′ of the container 100′.

The main shelter body 110′ (which is depicted without its top portion (roof) and end portions (end walls) for purposes of clarity) is characterized by a main shelter area 107′ including a right side opening (not labeled) and left side opening 114 through which sub-shelter assemblies 120′ and 130′ extend/retract, respectively. This provides, in at least some embodiments, an “enclosed space multiplier” effect in that available enclosed space for the shelter can be quickly expanded from that which might be provided by the container 100′ without these sub-shelter assemblies.

As may be seen, sub-shelter assemblies 120′ and 130′ each generally form volumes in the form of rectangular boxes, although in other embodiments, other shaped volumes may be utilized (e.g., the roofs may be sloped away from the main shelter body 110′, the volumes may be square boxes, etc.). These sub-shelter assemblies have outer boundaries (e.g., walls, doors, etc.) which, along with the main shelter body 110′, establish the boundaries of the shelter.

By way of example only and not by way of limitation, the container 100′ includes one or more telescopic support assemblies (not shown) corresponding to, in some embodiments, one or more or all of telescopic supports 1001-1004 and/or variations thereof (e.g., in some embodiments, the telescopic supports are not powered, and thus the sub-shelter assemblies 120′ and 130′ may be moved via a separate drive system (or a manual system) not directly associated with the telescopic supports). The telescopic supports support the sub-shelter assemblies 120′ and 130′ in a manner that is the same as and/or analogous to the manner by which the telescopic supports support the sub-shelter assemblies 120 and 130 of the trailer 100.

The following teachings are described with reference to the container 100′ of FIG. 1C. However, it is noted that the teachings herein may be, in some embodiments, equally applicable to technology associated with the trailer 100 and the container 100′. Collectively, the trailer and the container and other applicable shelters may be collectively referred to as mobile enclosures.

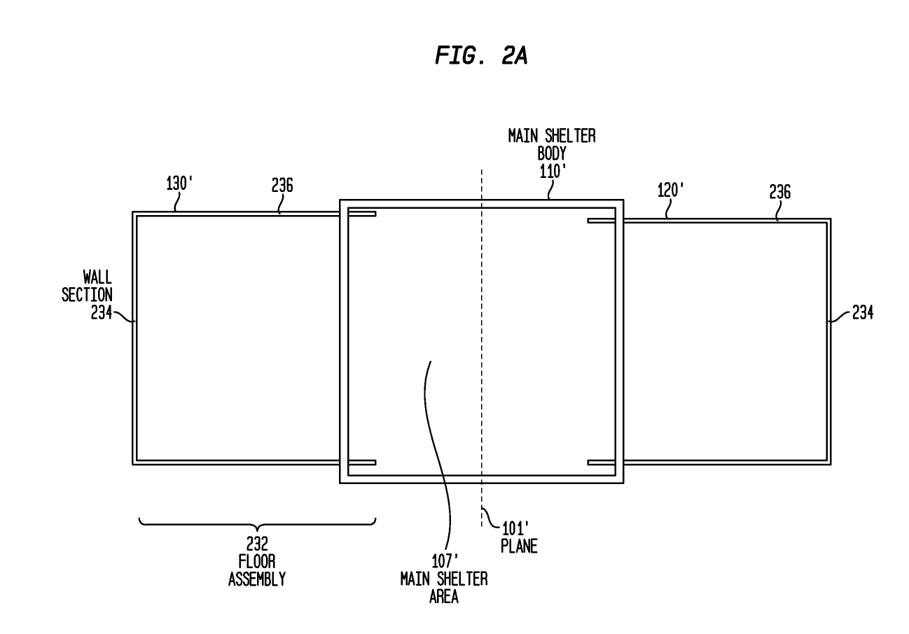

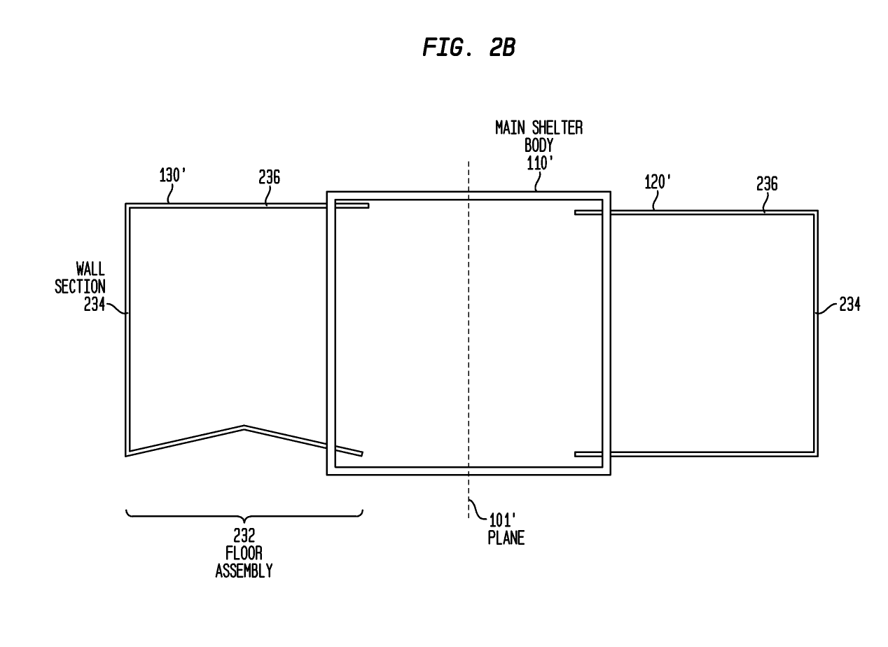

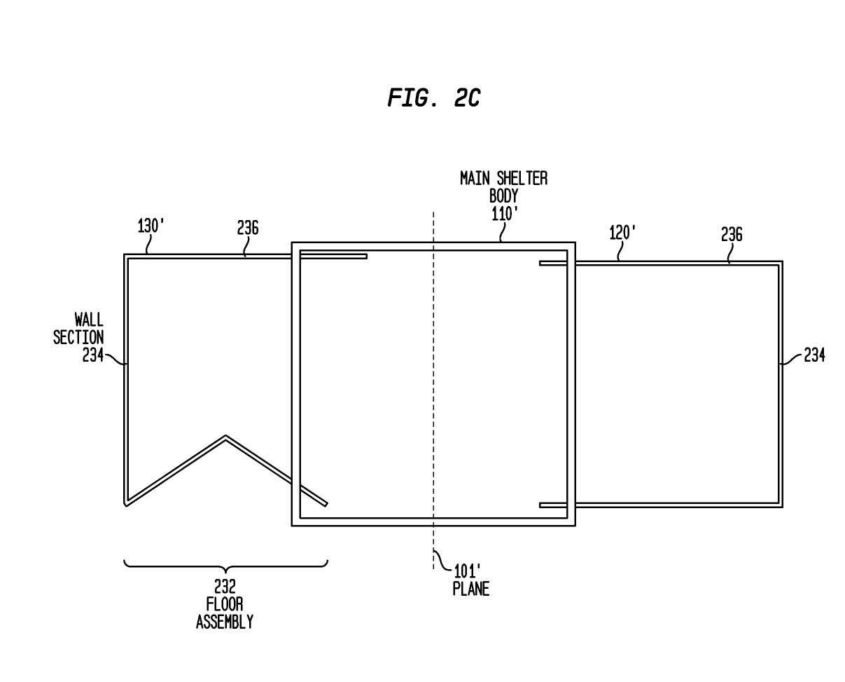

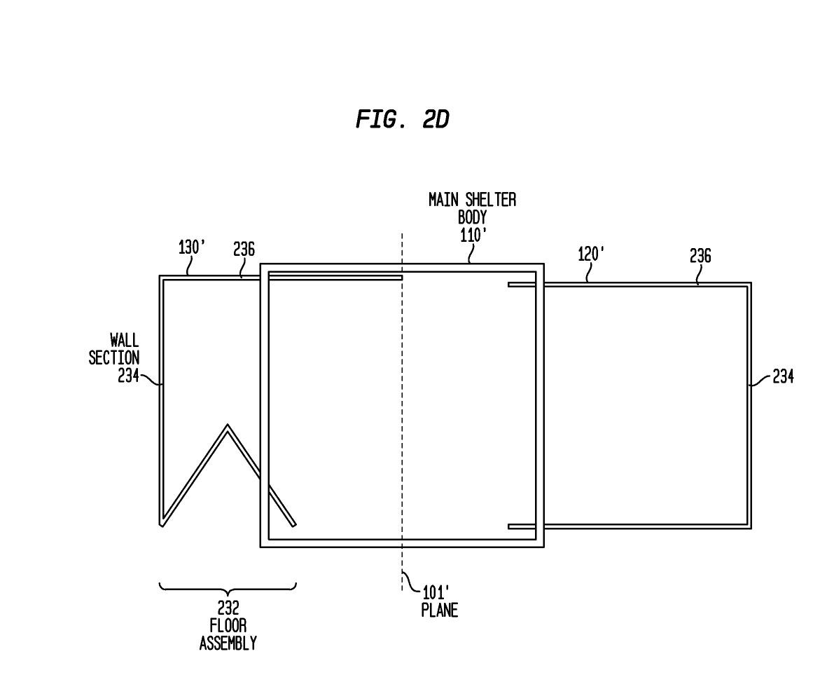

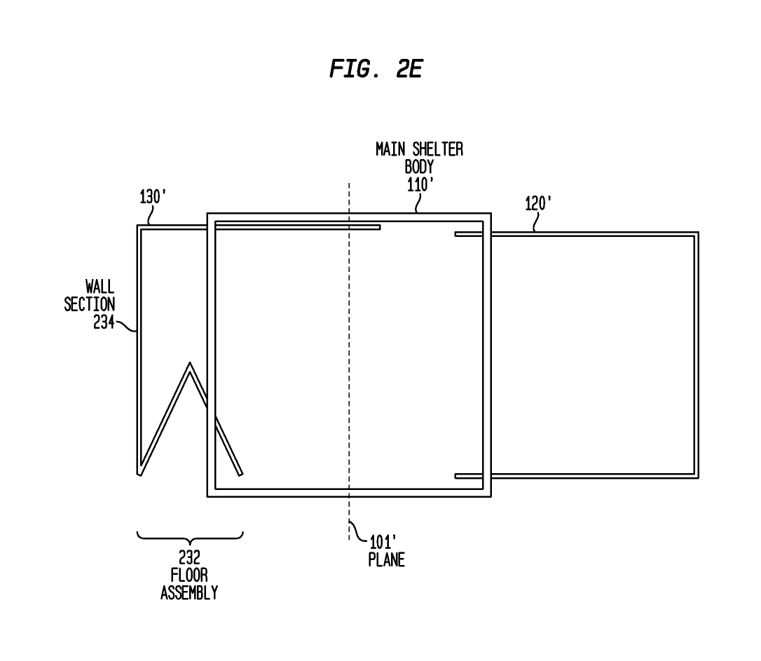

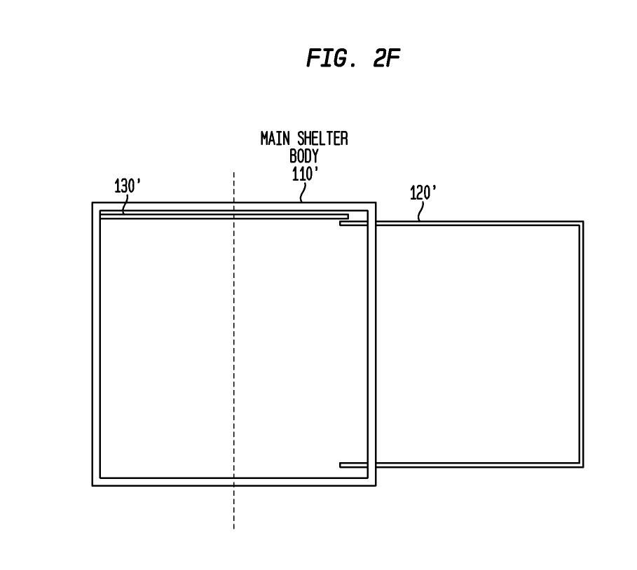

FIGS. 2A-2F depict a series of time-elapsed functional views of a cross-section of the container 100′ taken on a plane normal to plane 101′ located at about the middle of the container 100′ (relative to the longitudinal direction thereof) during retraction of the sub-shelter assembly 130′ while the sub-shelter assembly 120′ remains in its fully extended position. As may be seen from the figures, the floor assembly 232 of the sub-shelter 130′ folds upward during refraction of the sub-shelter assembly 130′. This feature is also present with respect to sub-shelter 120′, and would be depicted in FIGS. 2A to 2F if sub-shelter 120′ was being retracted. In at least some embodiments, the floor assembly 232 folds upward in order to provide space for the sub-assemblies to be retracted into the main body 110, while outer wall section 234 and roof section 236 remain generally in the same configuration. In this regard, the functionality of the floor assembly 232 is different than that of the tops (roof sections 236) of the sub-shelters which, as may be seen in the FIGs., interleave with each other.

Additional details of some of the features of the floor assemblies of some embodiments are described next below.

As noted above, at least some of the telescopic supports are powered to extend and retract and/or the sub-shelters are configured to extend and retract via alternative sources of power. Owing to the fact that the supports are connected to the sub-shelters at the ends of the supports, retraction of the supports retracts the sub-shelters (i.e., a tension force is applied to the bottom portions of the sub-shelters which results in the sub-shelters being pulled (retracted) into the main shelter body 110′). In an alternative embodiment where the telescopic supports are not powered (a separate system is used to extend/retract the sub-shelters), other retraction forces applied to the sub-shelters still results in the sub-shelters being pulled (or pushed) into the main shelter body 110′. In this regard, an embodiment of the technology includes a purely mechanical structural apparatus (e.g., no hydraulic or electric motors/actuators, etc.) that at least initiates folding of the floor assembly 232 upward as a result of retraction of the sub-shelter 130′ (and likewise for the sub-shelter 120′). In this regard, an embodiment of the technology includes an apparatus that at least initiates folding of the floor assembly 232 upward as a result of retraction of the sub-shelter 130′ (and likewise for the sub-shelter 120′) via a non-powered force.

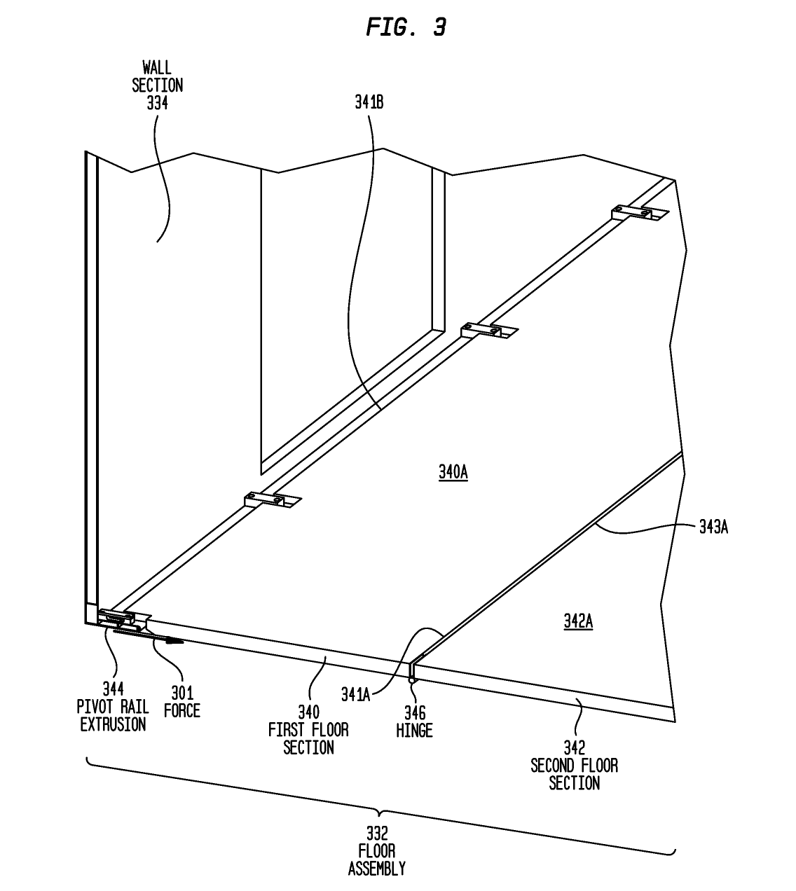

FIG. 3 depicts a perspective view of a section of the sub-shelter 130′ taken through the plane on which FIGS. 2A-2F lie at a temporal location corresponding to that of FIG. 2A. As may be seen, when sub-shelter 130′ is at its fully extended location, the floor assembly 332, which corresponds to floor assembly 232 of FIGS. 2A-2F lies level (i.e., normal to the direction of gravity) and is normal to wall section 334, which corresponds to wall section 234 of FIGS. 2A-2F. The outboard floor panel 340 includes a usable surface 340A configured for a person to walk on and/or stand on, wherein the usable surface extends generally in a common plane and is configured to be walked on when the floor assembly 332 is in an unfolded state. The floor assembly 332 includes an inboard floor panel 342. The inboard floor panel 342 includes a top surface 342A configured to support loads associated with its intended use, such as, for example, for a person to walk on and/or stand on the surface 342A. The floor assembly 332 is configured such that outboard floor panel 340 and inboard floor panel 342 fold. When the floor assembly 342 is in the unfolded state (sometimes referred to as the open state), the top surface extends generally in the common plane and is configured to be used when the floor assembly 332 is in an open or unfolded state. The floor assembly 332 further includes a pivot rail extrusion 344 attached to/fixedly linked to wall section 334 (as discussed in greater detail below). Outboard floor panel 340 is mechanically linked to inboard floor panel 342 via hinge 346, and mechanically linked to wall section 334 via the pivot rail extrusion 344, as will be detailed below. In this regard, outboard floor panel 340 and inboard floor panel 342 are pivotally mounted to each other. Conceptually, neighboring floor panels or floor sections can be considered to be pivotally mounted to each other. As noted above, outboard floor panel 340 and inboard floor panel 342 fold; that is, transition from the open state in which floor sections 340 and 342 reside in a same plane, to a closed or folded state. Upon application of sufficient compressive force, such as force 301 on outboard floor panel 340, the edges 341A, 343A of floor sections 340, 342, respectively, rise out of the plane of the floor sections and rotate relative to each other due to the hinge 346 thereby resulting in the aforementioned folding of the floor assembly 332. As will be understood from the figures, unlike edges 341A and 343A, edges 341B and 343B (see FIG. 8, discussed below) of floor sections 340, 342, respectively, generally do not rise out of the plane of the floor sections. As may be seen, edges 341A, 341B, 343A and 343B are generally parallel to each other and are orthogonal to the direction of folding and unfolding of the floor assembly 332 (e.g., orthogonal to the direction of arrow 810 with respect to FIG. 8). Also as may be seen, the edges 341A and 343A are proximate to each other, and edges 341B and 343B are remote from each other.

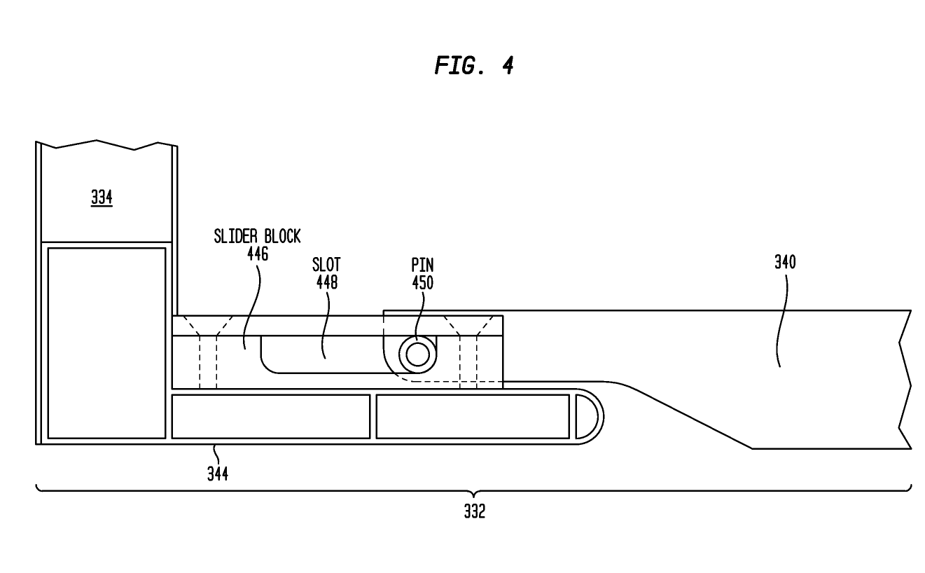

FIG. 4 depicts a close-up view of the portion of the sub-shelter 130′ where the wall section 334 meets the floor assembly 332. Briefly, it is noted that the floor assembly 332 includes portions that extend in the vertical direction. Accordingly, as used herein, the phrase floor assembly and the like may include portions that might otherwise be considered part of a wall.

FIG. 4 depicts a slider block 446 fixedly mounted, via bolts or the like, to horizontal pivot rail extrusion 344. Slider block 446 includes a slot 448 therein in which a bearing 450 is located. Bearing 450 may be a pin or a roller (a roller is utilized in the embodiments detailed herein, as will be seen below). Any device, system and/or method that will enable the teachings detailed herein and/or variations thereof to be practiced may be used in some embodiments. Bearing 450 is connected to the outboard floor panel 340 and moves with outboard floor panel 340. Bearing 450 slides and/or rolls within slot 348 upon movement of the pivot rail extrusion section 344 relative to outboard floor panel 340. (In this regard, pivot rail extrusion 340 is sometimes referred to herein as a horizontal traveler owing to its horizontal movement, or traveler.) Bearing 450 and slider block 446 collectively act as a hinge, permitting edge outboard floor panel 340 to fold (edge 341A rises and falls) relative to the pivot rail extrusion 344, as will be described below. Bearing 450 and slider block 446 also collectively act as a slider assembly in that the bearing 450 slides within the slot 348, thus permitting the bearing 450 (and thus the outboard floor section 340) to slide relative to the slider block 446 (and thus the pivot rail extrusion 344 and the wall section 334)/permitting the slider block 446 to slide relative to the bearing 450. Accordingly, in the exemplary embodiment depicted in the FIGs., the bearing 450 and slider block 446 collectively act as a slider hinge. While not shown, there is a pin and barrel function as a hinge at edge 343B that permit edge 343B to rotate relative structure of the container 100′ supporting the pin or barrel, whichever the case may be, while at least generally preventing edge 343B from rising and/or falling relative to the pivot rail extrusion or other reference structure. That is, inboard floor panel 342 is pivotally mounted to the main shelter body 110′. More particularly, inboard floor panel is hingedly mounted to a floor section of the main shelter body 110′ or other structure thereof such that the inboard floor panel is generally parallel to the floor section and/or level with the floor section of the main shelter body 110′ when the floor assembly 332 is in the unfolded (open) state.

As will be understood from the FIGs., the outboard floor panel 340 is pivotally coupled to the movable portion of the container 100′ (i.e., the sub-shelter assembly 120′ or 130′), and the second floor panel 342 is pivotally coupled to the stationary portion of the container 100′ (i.e., the main shelter body 110′ or structure fixedly mounted to the main shelter body 110). As will be further understood, when the floor assembly 332 is folded, the pairs of edges proximate each other of the panels (i.e., edges 341A and 343A) rise with each other.

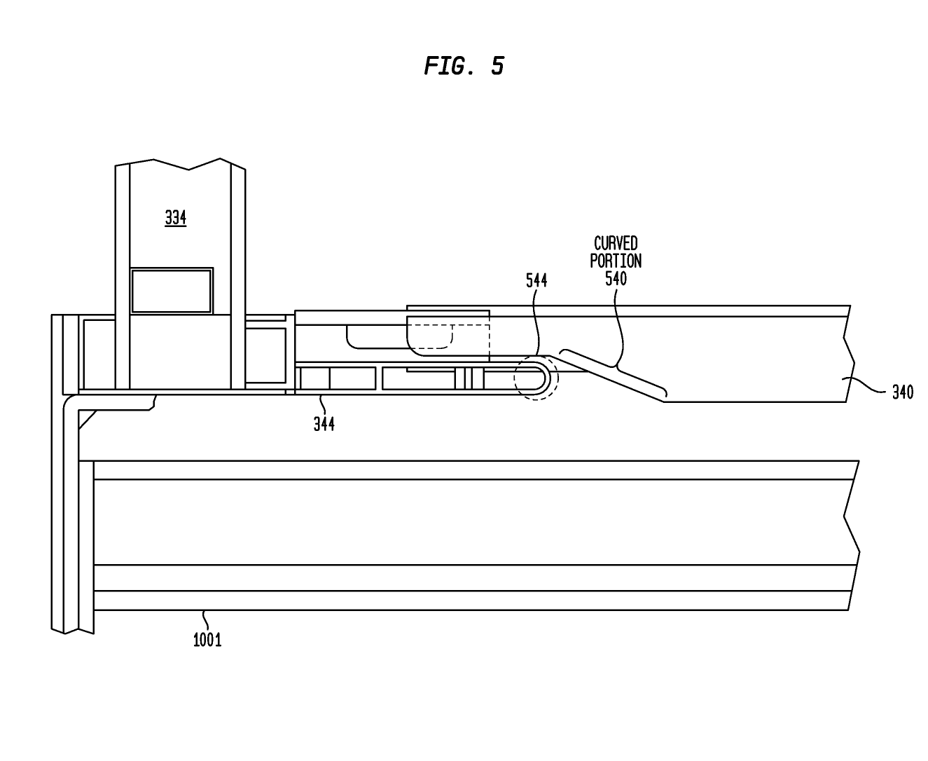

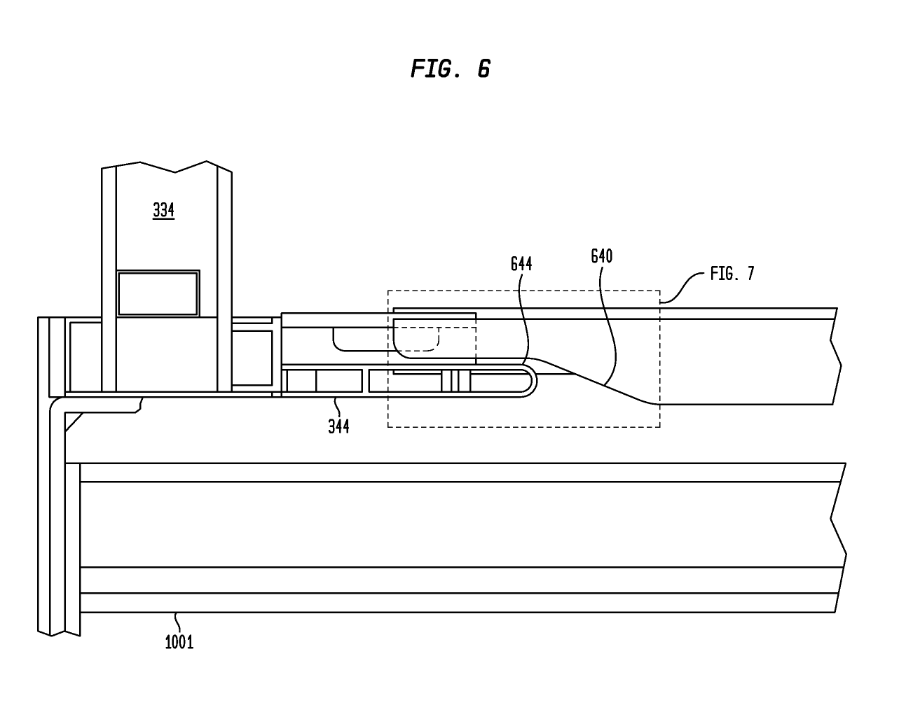

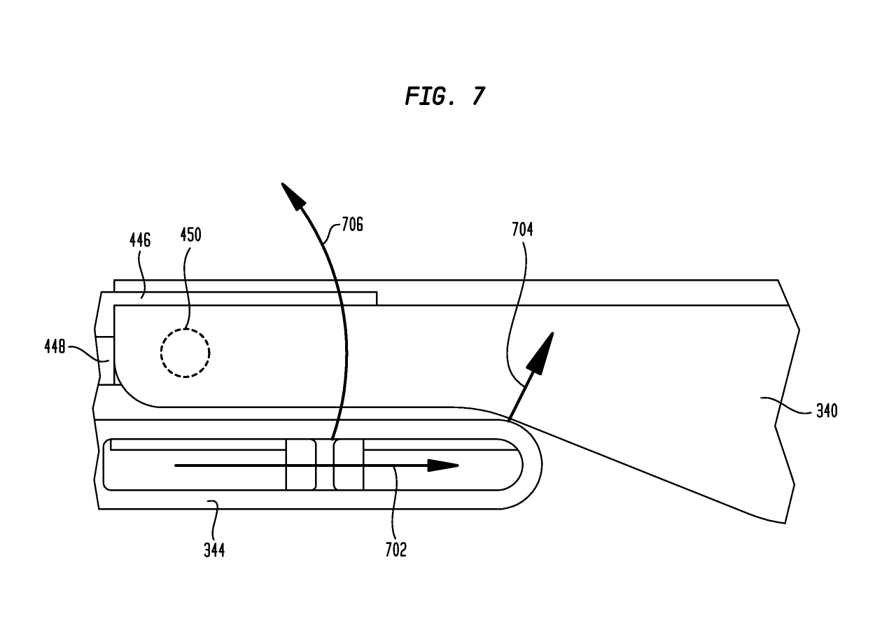

FIGS. 5 to 11 depict portions of the floor assembly 332 at various temporal stages during the folding process. FIGS. 5 to 11 are to scale, although other embodiments may have relative dimensions that differ from those of the FIGs. FIG. 5 is a view that is normal to the plane 101′, looking forward (i.e., toward the front of the container, identified by reference 100A′) when positioned in back (identified by reference number 100B′ of the container 100′), and depicts a close-up view of the outboard portion of the floor assembly 332, along with a telescopic support 1001. FIG. 5 depicts the sub-shelter 130′ at a location that is at least about its fully extended location relative to the main shelter body 110′ (the bearing 450 may also abut the end of slot 448, as depicted in FIG. 4). Upon actuation of the telescopic supports to retract the sub-shelter 130 into the main trailer body 110′, the pivot rail extrusion 344 is pushed and/or pulled towards the main shelter body 110′, and thus towards the outboard floor panel 340 (including towards edge 341A and 341B). Slot 448 is sized and dimensioned such that pivot rail extrusion 344 may move relative to outboard floor panel 340 such that a forward section (e.g., that located within dashed circle 544) of the pivot rail extrusion 344 makes contact with the canted portion 540 of the outboard floor panel 340. FIG. 6 depicts an initial contact between a rounded surface 644 of the pivot rail extrusion 344 and a flat surface 640 (e.g., the canted portion 540) of the outboard floor panel 340. FIG. 7 is a close-up view of the portion within circle 7-7. Arrow 702 represents the direction of movement of pivot rail extrusion 344, while arrow 704 represents force applied to the outboard floor panel 340 due to the movement of the pivot rail extrusion 344. In an exemplary embodiment, this results in a moment applied to the outboard floor panel 340 about bearing 450/about a portion of the pivot rail extrusion 344, represented by arrow 706. In this regard, the outboard floor panel 340 is configured to rotate about an axis that is normal to the direction of movement of the pivot rail extrusion 344 and parallel to a plane on which the usable surface 340A of the outboard floor panel 340 lies, and the moment 706 is likewise about this axis, this axis being the longitudinal axis of the bearing 450 wherever it is located (hereinafter, this axis is sometimes referred to as the bearing axis). It is noted that in some embodiments, the bearing 450 may instead be fixed relative to the pivot rail extrusion 344, and the slot 448 may instead be located in the outboard floor panel 340.

It is noted that in the embodiments depicted herein, the pivot rail extrusion 344 is restrained from rotating about the bearing axis or otherwise moving in a direction other than that along arrow 702, thereby providing sufficient force to the outboard floor panel 340 to impart a sufficient moment 706 thereto.

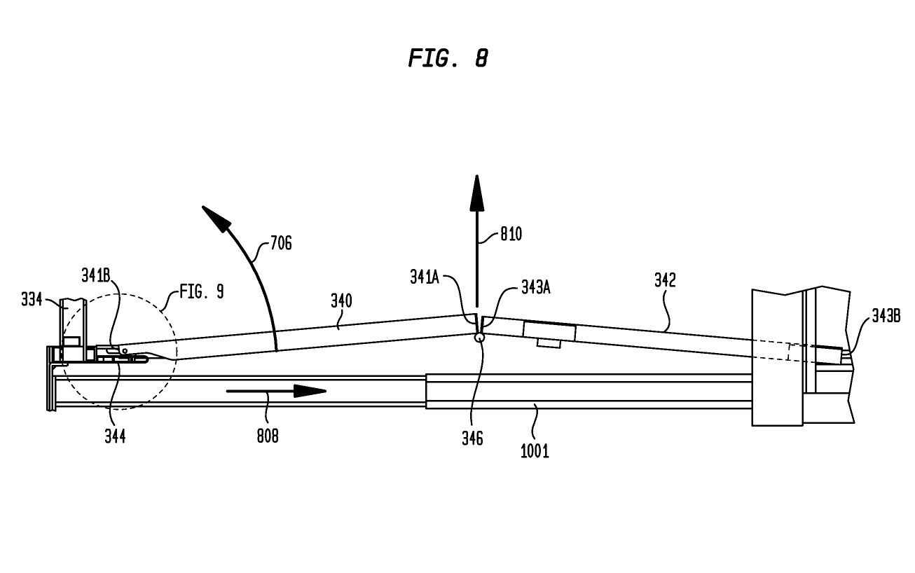

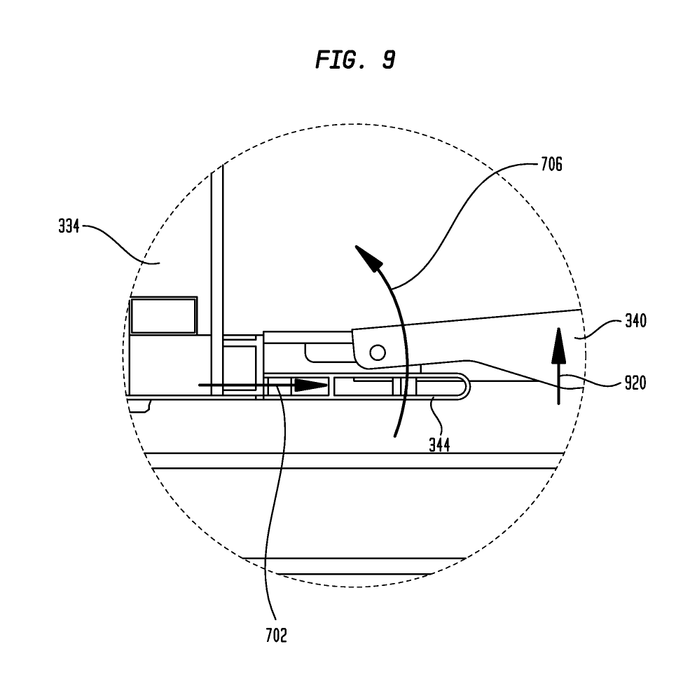

In the exemplary embodiment depicted in the figures, the pivot rail extrusion 344 has at least a two-dimensional bulbous forward section (e.g., a semi-circular cross-section lying in a plane normal to plane 101′ and normal to the surface 340A), and the outboard floor panel 340 has a canted portion 540. This functions the same as and/or similar to or otherwise provides the same or similar effect as a cam system. That is, movement of the pivot rail extrusion 344 in the horizontal direction forces the outboard floor panel 340 upward as the pivot rail extrusion 344 moves along the canted portion 540 of the outboard floor panel. In this regard, consistent with the above, the container 100′ is configured such that the pivot rail extrusion 344 generally only moves in the horizontal direction, and generally does not move in any other direction (e.g., vertical direction, etc.) Because the pivot rail extrusion 344 will not move “out of the way” of the outboard floor panel 340, and because the outboard floor panel 340 will move (be pushed) “out of the way” of the pivot rail extrusion 344 (due to the fact that it is configured to rotate/fold upwards, owing to the geometry depicted in the figures and/or variations thereof), the outboard floor panel 340 rotates counter-clockwise about bearing 450 due to moment 706. This movement is depicted in FIGS. 8 and 9, where FIG. 9 depicts a close-up view of the structure within circle 9-9 of FIG. 8. Arrow 808 depicts movement of the front tube assembly of the telescopic support 101 towards the main shelter body 110′ during retraction of sub-shelter 130, and thus corresponding movement of pivot rail extrusion 344. Arrow 810 depicts movement of the hinged portion of the floor assembly 332 due at least in part to the moment 706 applied to the outboard floor panel 340. In this regard, the moment 706 imparted onto the outboard floor panel moves the location where the outboard floor panel 340 is linked to the second floor panel 342 in a direction that is at least about normal to the plane formed by the outboard and inboard floor panels on which users of the container 100′ walk and/or stand represented by arrow 810. Accordingly, movement of this location moves the second floor panel 342. As may be seen in FIG. 8, the planes of the usable surfaces of the outboard and inboard floor panels are moved out of the plane on which they previously were located to a position such that they are at a non-zero angle to that plane. Arrow 920 of FIG. 9 depicts the direction of movement of the outboard floor panel 340.

It is noted that the structure depicted in the FIGs. and/or described herein is exemplary. In this regard, instead of and/or in addition to the canted portion 540, a wedge or other ramp-like surface may be used. In other embodiments, instead of a planar canted portion, a curved portion may be used. Note further that in other embodiments, any surface functioning as the canted portion 540 may not necessarily be smooth, although a smooth surface has utilitarian attributes that may not necessarily be achieved via a non-smooth surface. Indeed, in some embodiments, any surface that has a portion that is not normal to and not parallel with the direction of arrow 702 may be used in some embodiments, providing that the teachings detailed herein and/or variations thereof may be enabled.

Further in this regard, instead of and/or in addition to the curved bulbous forward section of the pivot rail extrusion 344 depicted in the figures, a more blunt shape may be used. A wedge and/or a canted portion opposite and/or generally opposite to the canted portion 540 may be used in some embodiments instead of and/or in addition to the smooth bulbous portion. Other curved surfaces may be used. It is further noted that consistent with the transposition of the bearing 450 and the slot 448 detailed above, the configurations of the canted portion 540 and the bulbous portion of the pivot rail extrusion may be transposed. Any device, system and/or method that will enable the teachings detailed herein and/or variations thereof to be practiced may be utilized in some embodiments.

It is also noted that while the embodiments detailed herein depict the pivot rail extrusion 344 being pushed towards the outboard floor panel 340, other embodiments may be such that the pivot rail extrusion is pulled towards the outboard floor panel 340.

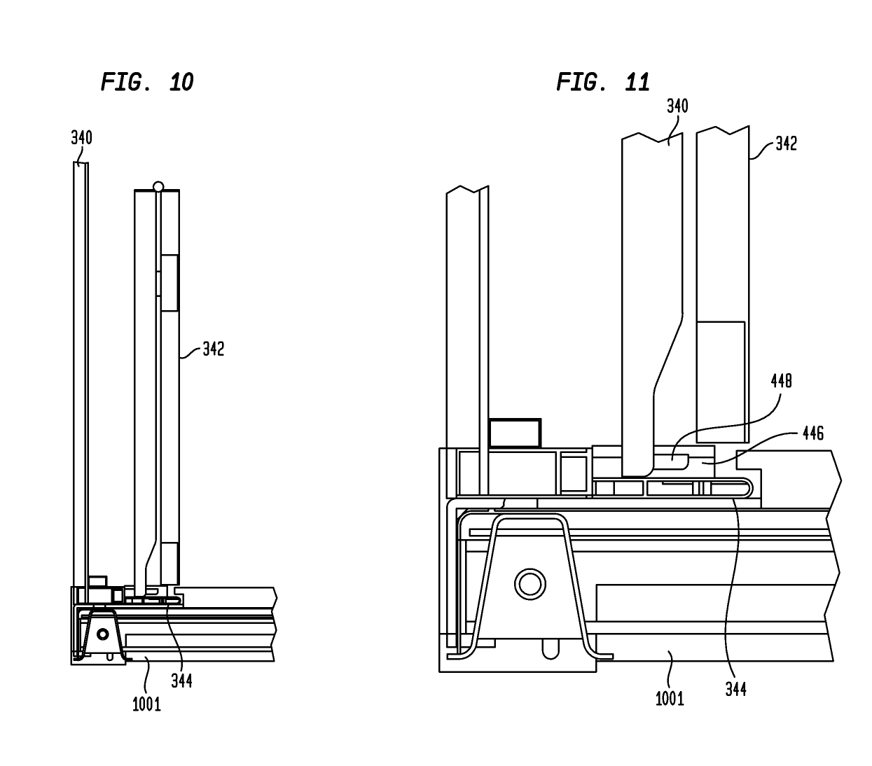

As the pivot rail extrusion moves inboard toward the main shelter body 110, the floor assembly 332 continues to fold, as is depicted in FIGS. 2A-2F above. Ultimately, the pivot rail extrusion is moved to a position where it does not travel inboard any further (and thus the sub-shelter 130′ is moved to a position where it does not travel inboard any further—i.e., to a position where it is adequately located within main shelter body 110′ such that container 100′ can be moved to another location. FIG. 10 depicts a view of the floor assembly 332 at this location (fully folded), and FIG. 11 depicts a close-up view of a portion of the view of FIG. 10. It is noted that while FIGS. 10 and 11 depict the floor assembly 332 having the respective panels parallel to one another, and normal to the floor of the main body 110′, in other embodiment, this may not be the case. For example, one or both of the floor panels may be at a non-normal angle with respect to floor of the main body 110′.

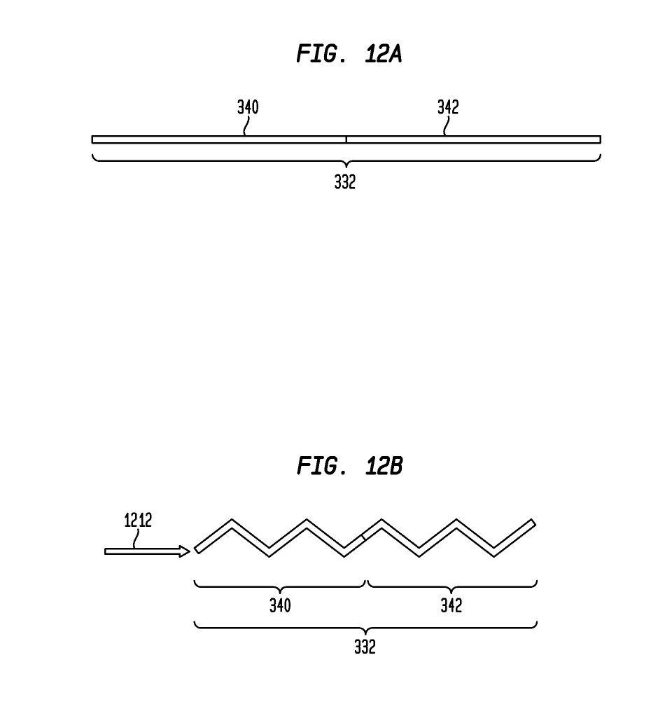

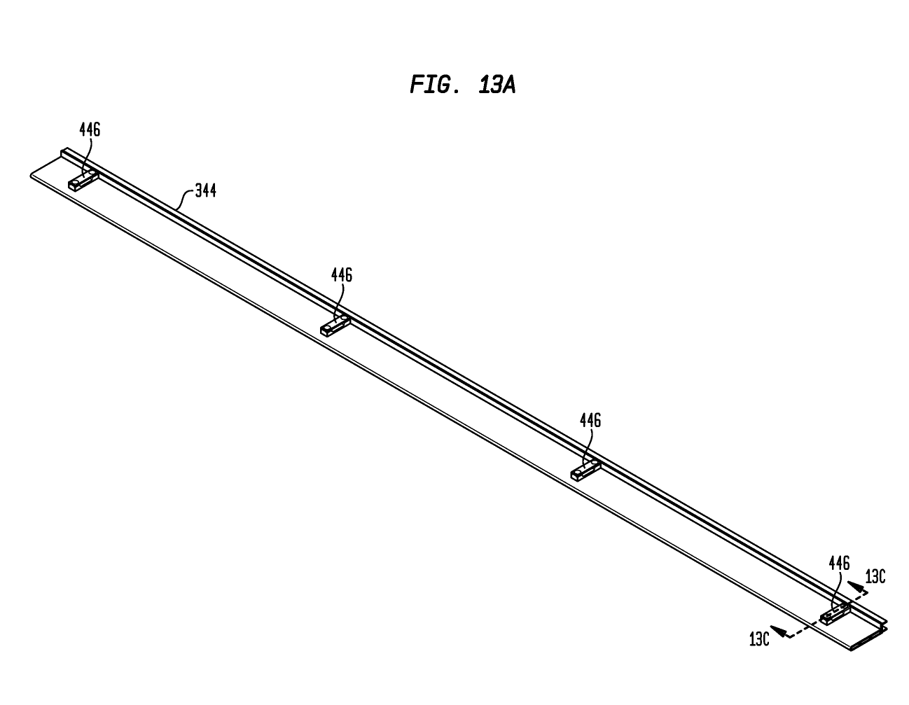

It is noted that additional forces can contribute to the folding of the floor assembly 332. In this regard, as the pivot rail extrusion 334 moves inboard, it applies a horizontal force to the bearing 450. This force also contributes to the forces and/or moments associated with folding the floor assembly 332. Indeed, after the canted portion 540 is clear of contact with the pivot rail extrusion 344, this constitutes all or at least substantially all of the forces applied to the floor assembly 332. In this regard, the interaction of the forward portion of the pivot rail extrusion 344 with the canted portion 540 of the outboard floor panel 340 provides the initial moment to commence folding of the floor assembly 332. Along these lines, in at least some embodiments, the floor assembly 332 may be such that the respective panels are perfectly aligned with one another when in the fully extended position. Upon application of a horizontal force by the pivot rail extrusion 344 to the outboard floor panel 340, without the moment resulting from the interaction of the pivot rail extrusion 344 with the canted portion 540 detailed above, the floor assembly 332 may not fold because the forces are perfectly aligned with the floor panels, which are also perfectly aligned with one another. FIGS. 12A and 12B provide functional schematics of this phenomenon, where FIG. 12A depicts, perfect alignment of the floor panels 340 and 342, and FIG. 12B depicts, in an exaggerated manner, how the floor assembly 332 may be driven to failure (crumpling) due to application of a horizontal force represented by arrow 1212 to the outboard floor panel 340, without the moment resulting from the interaction of the pivot rail extrusion 344 with the canted portion 540 detailed above.

Conversely, if a sufficient moment is applied to the outboard floor panel 340 as detailed above, the effects of the perfectly aligned panels can be overcome, and the floor assembly can be folded in the correct direction. In this regard, at least some embodiments are directed towards devices, systems and methods, such as those detailed herein and/or variations thereof, that overcome the effects of the perfectly aligned panels so as to permit the folding of the floor assembly to at least commence. Accordingly, at least some embodiments are directed towards devices, systems and/or methods, such as those detailed herein and/or variations thereof, that provide a purely solid mechanical structural apparatus (e.g., no hydraulic or electric motors/actuators, etc.) that initiate the folding of the floor assembly 332. In this regard, at least some embodiments are directed towards devices, systems and/or methods of a foldable floor assembly is configured to at least commence folding via a purely solid mechanical structural apparatus upon application of a force applied parallel to the usable surface(s) of the foldable floor assembly in the fully unfolded state.

Herein, the components detailed herein and/or variations thereof for providing the aforementioned moment to the effects of the perfectly aligned floor panels can be overcome, and the floor assembly can be folded in the correct direction, are referred to as a fold-start assembly, and the methods for accomplishing the same are referred to as the fold-start method.

Accordingly, without the fold-start apparatus/method, the outboard floor panel 340 and the inboard floor panel may simply contact each other without folding owing to the compressive force applied to the outboard floor panel. This compressive force may be absorbed by the hinges and floor panels. This compressive force will increase as more force is applied to the sub-shelter assembly by the telescopic support, corresponding to increased absorption of the force by the hinges and floor panels, until stresses and strains build up that cause flexure in a part of the structure that enables the floor panels to travel upward in the folding direction or a failure mode occurs (e.g., a pivotally coupled edge of the floor panel break loose, one or more of the floor panels collapse, the hinge 446 fails, etc.)

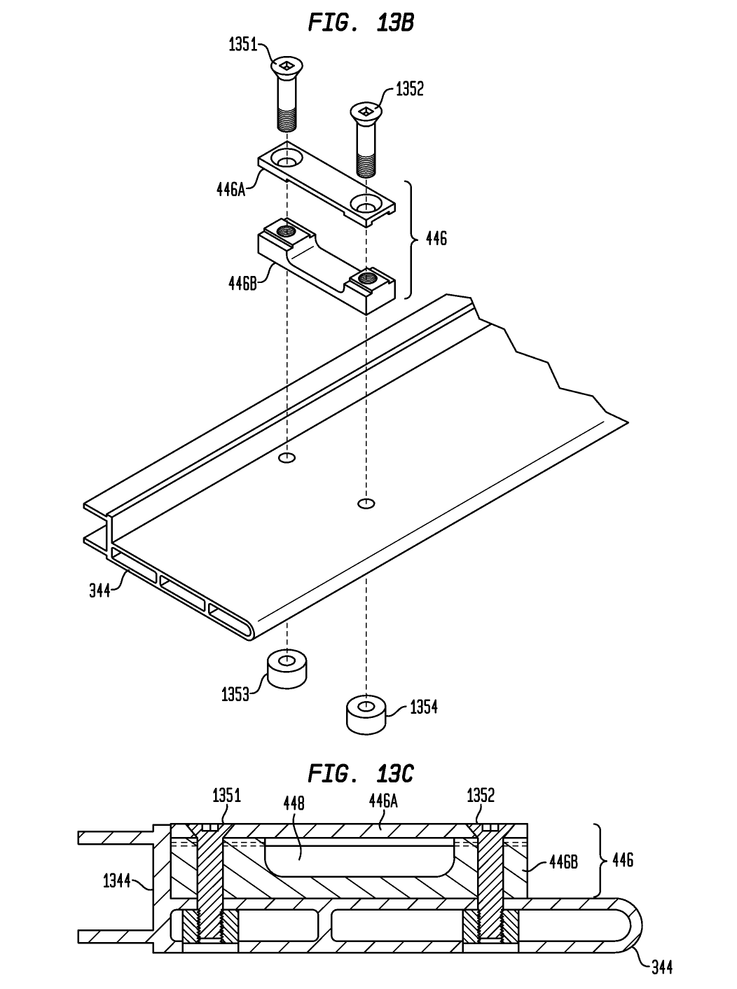

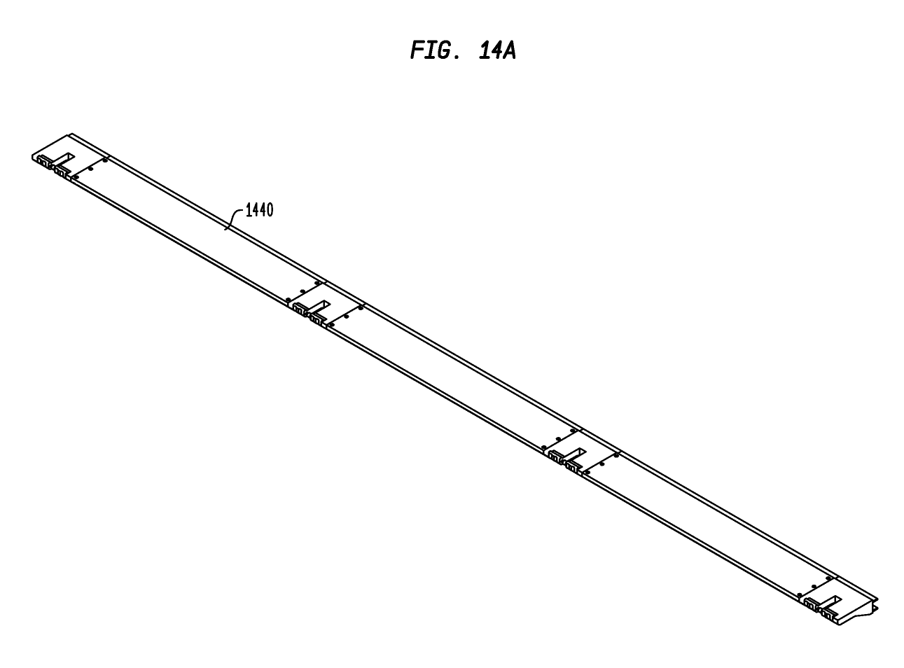

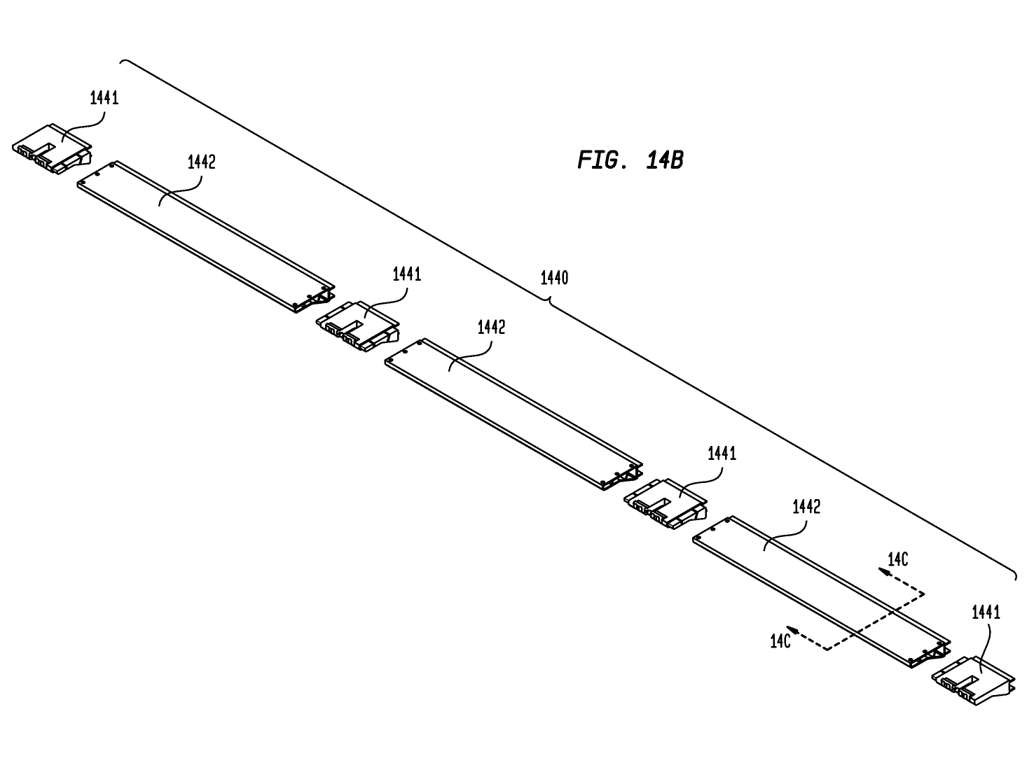

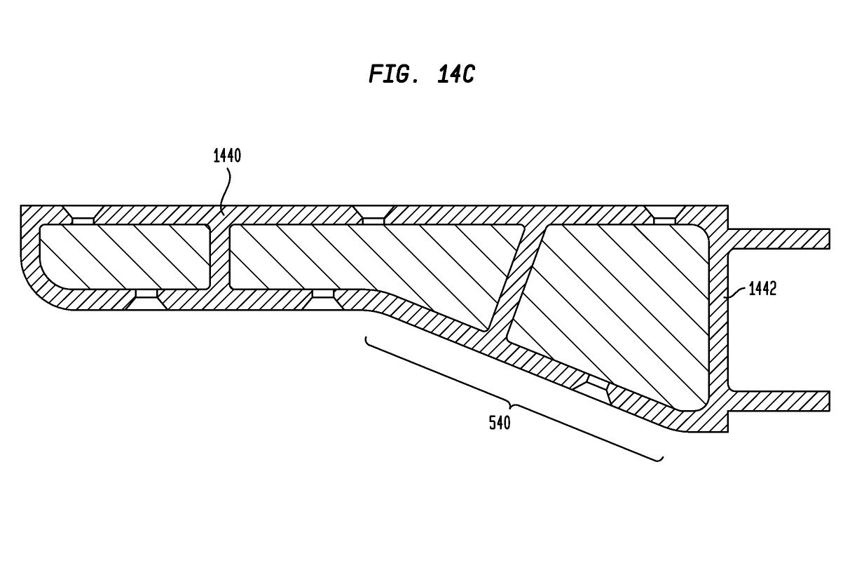

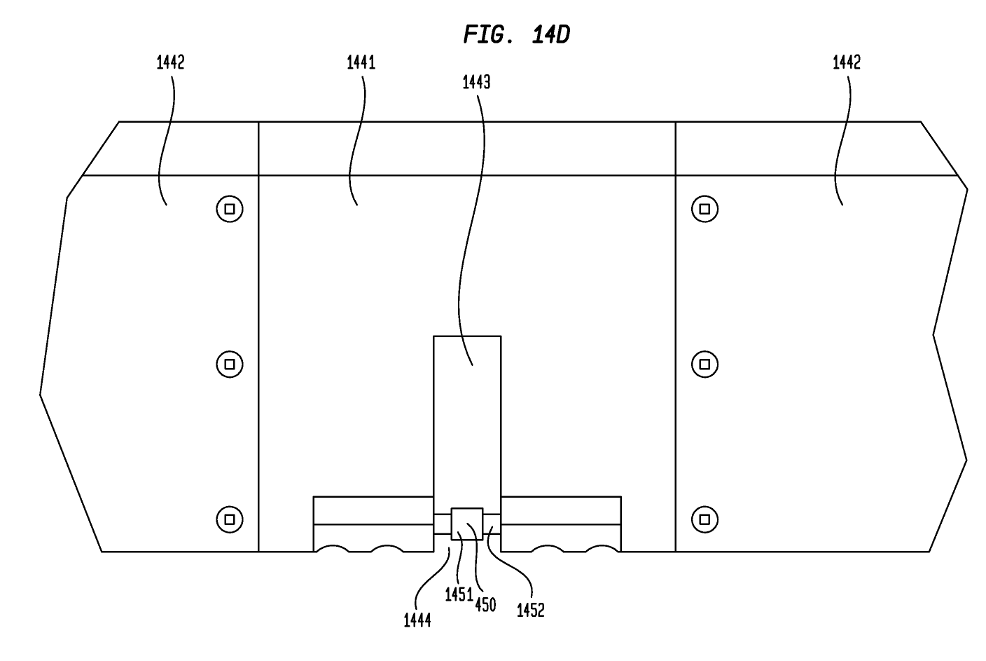

FIGS. 13A-14D present additional details associated with the pivot rail extrusion 344 and the outboard floor panel 340. In this regard, FIG. 13A depicts the pivot rail extrusion 344 unattached to the wall 334, etc., with the slider blocks 446 attached thereto. FIG. 13B depicts an exploded view of the assembly of the pivot rail extrusion 344 with a slider block 446. As may be seen, slider block 446 includes two sections 446A and 446B that are bolted together to form slot 448. The blots 1351 and 1352 not only are used to hold the two sections 446A and 446B together, but are also used to hold the slider block 446 to the pivot rail extrusion 344, along with tap blocks 1353 and 1354 (in an alternative embodiments, elements 1353 and 1354 may be nuts—any device, system and/or method of assembling the slider block 446 may be used in some embodiments). FIG. 13C depicts a cross-sectional view taken through the structure depicted in FIG. 13A.

Pivot rail extrusion 344 is configured to be attached to wall 334 via bracket 1344. Accordingly, pivot rail extrusion 344 may be removed and replaced from the container 100′ in the event of damage/wear. In the same vein, referring to FIG. 14A, an embodiment of outboard floor panel 340 includes a reaction assembly 1440 configured to be removed and replaced from/to structure making up the rest of the outboard floor panel 340. FIG. 14B depicts an exploded view of the reaction assembly 1440, showing bearing holding device 1441 and spacers 1442. FIG. 14C depicts a cross-sectional view through reaction assembly 1440, clearly showing canted portion 540. Reaction assembly 1440 is configured to be attached to the other portions of the outboard floor panel 340 via section 1442, thus permitting the reaction assembly 1440 to be removed and replaced from the container 100′ in the event of damage/wear.

FIG. 14D depicts a close-up view of one of the bearing holding devices 1441 flanked on either side by spacers 1442 of the reaction assembly 1440 of FIG. 14A, with the bearing 450 therein. The bearing holding device 1441 includes gaps 1443 and 1444 about bearing 450 to permit the slider block 446 to fit therein when the floor assembly 332 is fully flat (fully extended). In this regard, in an exemplary embodiment, bearing 450 is attached to the reaction assembly 1440, and then the reaction assembly 1440 is placed adjacent the pivot rail extrusion 344 with the bottom section of slider block 446 thereon and the slider block is then bolted together around the bearing (and thus to the pivot rail extrusion 344) to form the slit 448 and thus secure the pivot rail extrusion 344 to the outboard floor panel 340. As may be seen from FIG. 14D, bearing 450 comprises a roller bearing 1451 and a pin 1452 about which the roller bearing 1451 rolls while in slot 448.

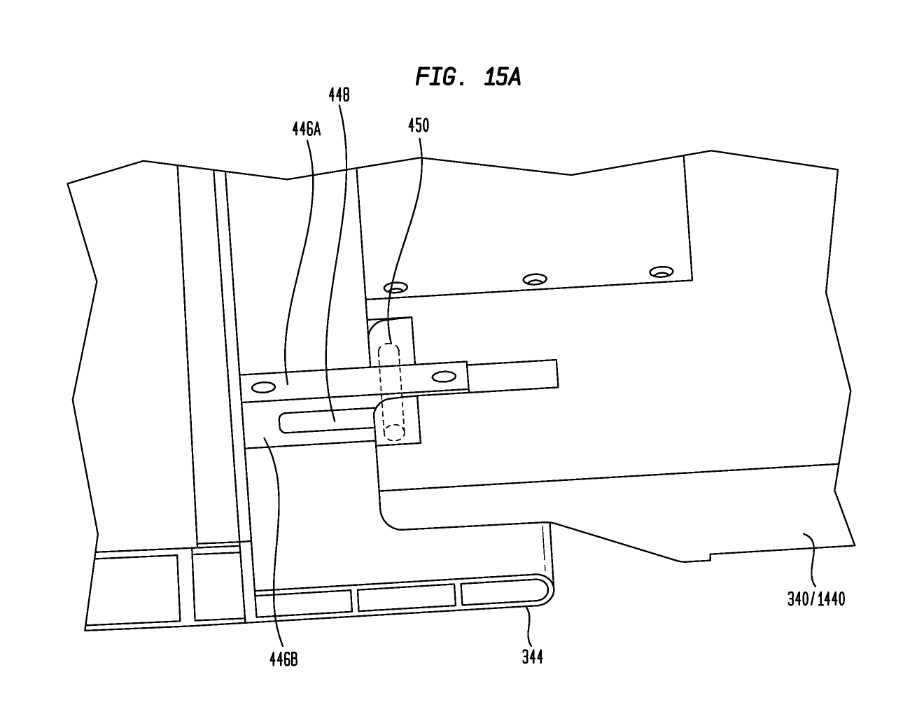

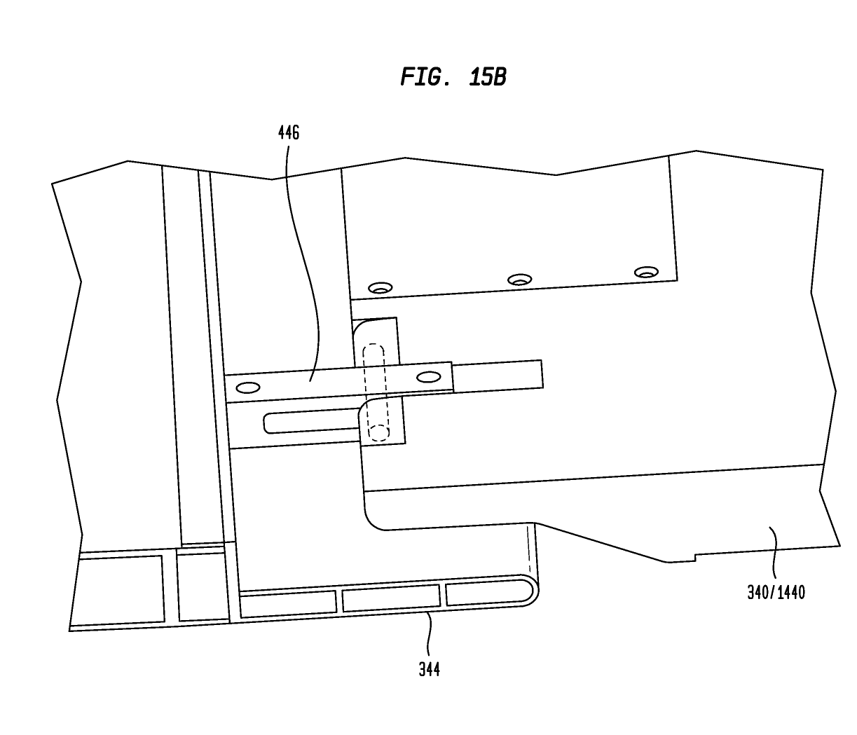

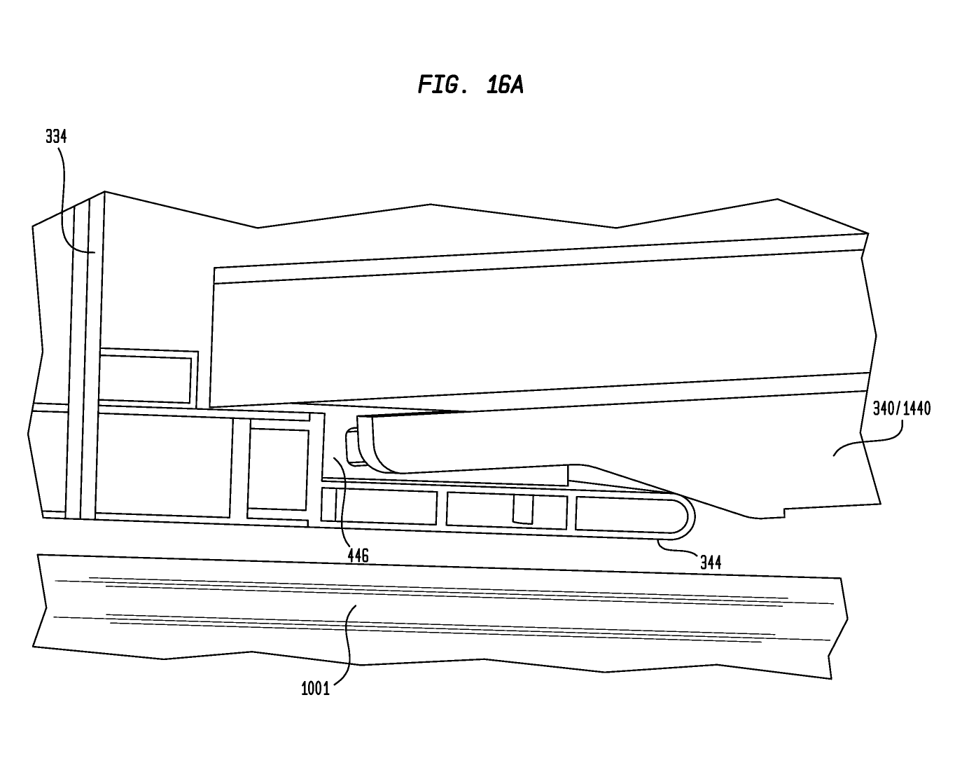

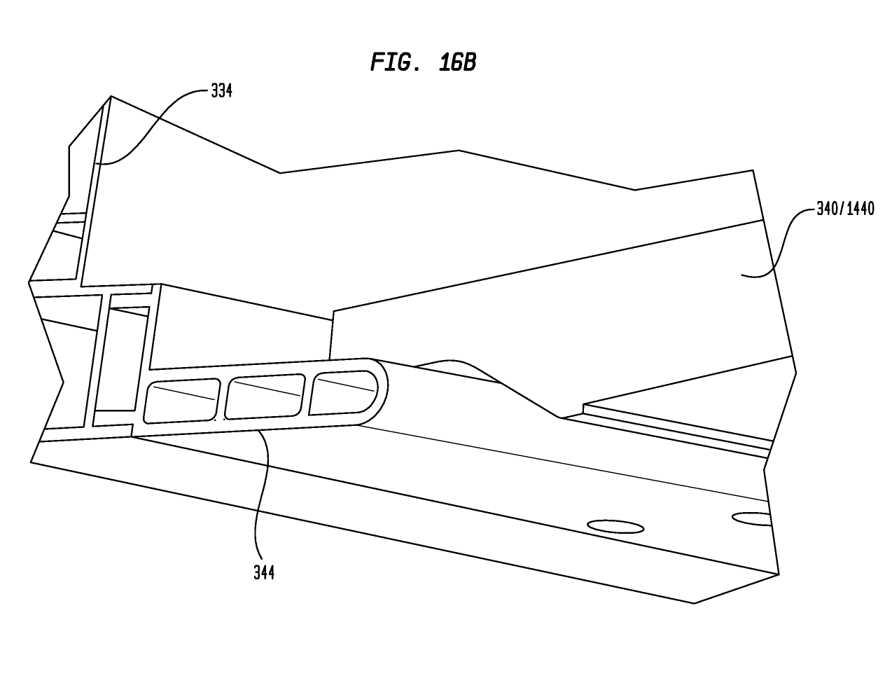

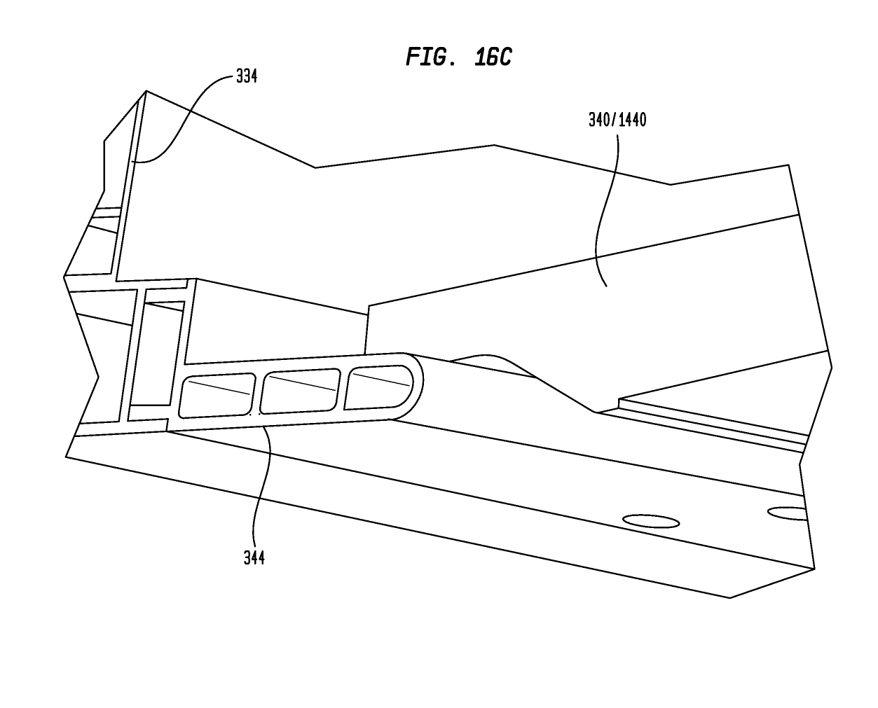

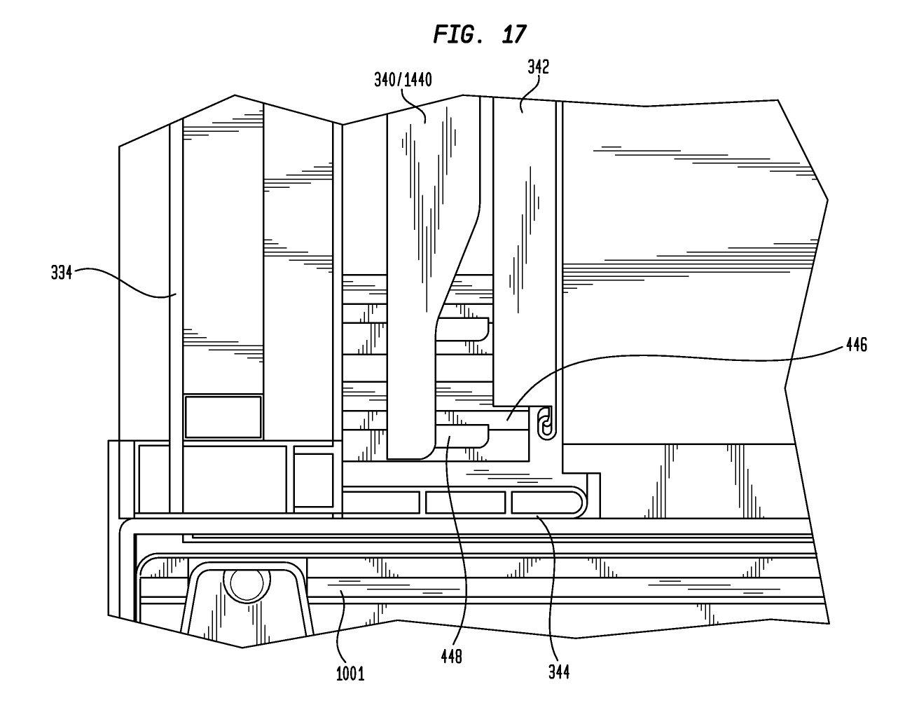

FIGS. 15A and 15B depict a perspective view of a portion of the floor assembly 332 detailed above in the condition where the floor assembly 332 is fully flat (fully extended). FIGS. 16A-16C depict isometric views of the portion of the floor assembly 332 depicted in FIGS. 15A and 15B (with FIGS. 16B and 16C depicting views from the same perspective) at a temporal location early on in the folding process of the floor assembly 332. As may be seen, the pivot rail extrusion 344 is pressing against the canted portion of the outboard floor panel 340, imparting a moment thereto and thus forcing the outboard floor panel 340 to rotate about the bearing 450 and thus folding the floor assembly 332. FIG. 17 depicts a perspective view of the floor panel 332 in its fully folded condition.

It is noted that while embodiments detailed herein depict the pivot rail extrusion 334 and the canted portion as being on the outboard side of the floor assembly 332, in other embodiments, these components may be located on the inboard side and/or at the middle (where hinge 346 is located). Any location of these components that will permit the floor assembly 332 to be folded as detailed herein and/or variations thereof may be used in some embodiments.

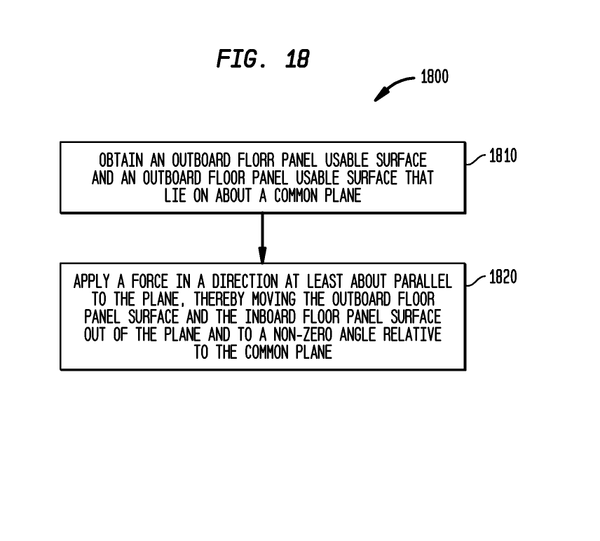

Embodiments include a method of folding a foldable floor, such that any of the floor assemblies detailed herein and/or variations thereof. Along these lines. FIG. 18 depicts an exemplary flowchart 1800 for such a method. In this regard, the exemplary method includes action 1810, which entails obtaining an outboard floor panel usable surface and an inboard floor panel usable surface that are planar to one another, and these planes generally lay on the same plane (the common plane) as one another. Such usable surfaces may correspond to the usable surfaces detailed herein and/or variations thereof. The exemplary method further includes action 1820, which entails applying a force in a direction at least about parallel to the common plane, thereby moving the outboard floor panel usable surface and the inboard floor panel usable surface out of the common plane and to a non-zero angle relative to the common plane.

While various embodiments of the present technology have been described above, it should be understood that they have been presented by way of example only, and not limitation. It will be apparent to persons skilled in the relevant art that various changes in form and detail can be made therein without departing from the spirit and scope of the technology. Thus, the breadth and scope of the present technology should not be limited by any of the above-described exemplary embodiments, but should be defined only in accordance with the following claims and their equivalents.

What is claimed is:

1. A foldable floor assembly, comprising:
an outboard floor panel apparatus including a bottom surface and a top usable surface generally extending in a floor plane and configured to be used when the foldable floor assembly is in an unfolded state; and
a pivot rail having an inboard surface, the pivot rail movable in a horizontal direction substantially parallel to the floor plane, wherein
movement of the inboard surface of the pivot rail in the horizontal direction toward the outboard floor panel apparatus imparts a moment onto the outboard floor panel apparatus when the bottom surface of the outboard floor panel apparatus and the inboard surface of the pivot rail are in contact with one another.

2. The foldable floor assembly of claim 1, wherein:
the moment is about a portion of the pivot rail.

3. The foldable floor assembly of claim 1, wherein:
the outboard floor panel apparatus is configured to rotate about a horizontal axis that is normal to the horizontal direction and parallel to the floor plane due to the moment.

4. The foldable floor assembly of claim 3, wherein:
the moment is about the horizontal axis.

5. The foldable floor assembly of claim 1, wherein:
the first floor panel apparatus is configured to rotate about a horizontal axis that is normal to the horizontal direction and parallel to the floor plane due to the moment, thereby folding the foldable floor assembly; and
the pivot rail is configured to not rotate about the horizontal axis during folding of the foldable floor assembly.

6. The foldable floor assembly of claim 1, wherein:
the bottom surface of the outboard floor panel apparatus includes a surface that is canted relative to the horizontal direction when the foldable floor assembly is in the unfolded state.

7. The foldable floor assembly of claim 1, wherein:
the bottom surface of the outboard floor panel apparatus includes a surface that is not normal to and not parallel with the horizontal direction when the foldable floor assembly is in the unfolded state.

8. The foldable floor assembly of claim 1, wherein:
the inboard surface of the pivot rail is curved.

9. The foldable floor assembly of claim 1, wherein:
the pivot rail includes an at least two-dimensional bulbous portion;
the inboard surface of the pivot rail is part of the bulbous portion;
the outboard floor panel apparatus includes a canted portion configured to interface with the inboard surface of the pivot rail; and
movement of the bulbous portion in the horizontal direction pushes the canted portion out of the way of the bulbous portion, thereby imparting the moment.

10. The foldable floor assembly of claim 1, wherein:
the pivot rail includes a forward curved section;
the inboard surface of the pivot rail is part of the bulbous portion;
the outboard floor panel apparatus includes a canted portion configured to interface with the inboard surface of the pivot rail; and
movement of the bulbous portion in the horizontal direction pushes the canted portion out of the way of the bulbous portion, thereby imparting the moment.

11. The foldable floor assembly of claim 1, further comprising:
an inboard floor panel apparatus hingedly linked to the outboard floor panel apparatus at a hinge location, wherein
the moment imparted onto the outboard floor panel moves the hinge in a direction that is at least about normal to the floor plane.

12. The foldable floor assembly of claim 11, wherein:
the outboard floor panel apparatus includes a top surface opposite the bottom surface of the floor panel; and
the top surface faces the direction of movement of the hinge.

13. The foldable floor assembly of claim 11, wherein:
the inboard floor panel apparatus includes an inboard floor panel usable surface that, when the foldable floor assembly is in an unfolded state, (i) extends generally in and/or at least about parallel to the floor plane and (ii) is configured to be walked on; and
movement of the hinge location moves the usable surface of the inboard floor panel to be at a non-zero angle to the floor plane.

14. The foldable floor assembly of claim 1, wherein:
the foldable floor assembly is configured to at least commence folding via a purely mechanical structural apparatus upon application of a force applied parallel to the horizontal direction.

15. The foldable floor assembly of claim 1, wherein:
the foldable floor assembly is configured to at least commence folding via a non-powered force.

16. A mobile shelter, comprising:
at least one sub-shelter including the foldable floor assembly of claim 1, wherein the sub-shelter is configured to extend outward from and retract inward towards a central location of the mobile shelter in a direction at least about parallel to the horizontal direction, wherein
the pivot rail is rigidly mechanically linked to the sub-shelter, and therefore configured to extend outward and retract inward with the sub-shelter, thereby moving the inboard surface of the pivot rail in the horizontal direction.

17. A method of folding a foldable floor, comprising:
(i) obtaining a planar outboard floor panel usable surface and a planar inboard floor panel usable surface that generally lie on the same floor plane as one another;
(ii) applying a force in a direction at least about parallel to the floor plane, thereby moving the outboard floor panel usable surface and the inboard floor panel usable surface out of the floor plane and to a non-zero angle relative to the floor plane.

18. The method of claim 17, wherein:
the method actions result in the application of a moment to the outboard floor panel usable surface due solely to the force.

19. The method of claim 17, wherein:
the direction is a horizontal direction;
the force is applied via movement of structure of the foldable floor in a direction parallel to the horizontal direction and towards a floor panel apparatus that includes the outboard floor panel usable surface.

20. A method, comprising:
obtaining a collapsible mobile shelter, wherein obtaining the mobile shelter includes executing action “i” of claim 17; and
collapsing the mobile shelter, wherein collapsing the mobile shelter includes executing action “ii” of claim 17.

21. A foldable floor assembly, comprising:
an outboard floor panel;
an inboard floor panel, wherein the inboard floor panel is hingedly linked to the outboard floor panel; and
a means for at least commencing folding of the outboard floor panel and the inboard floor panel together.

22. A mobile collapsible shelter; comprising:
a mobile enclosure, wherein the mobile enclosure includes a main shelter body and at least one sub-shelter assembly, the sub-shelter assembly configured to collapse into the main shelter body, wherein
the mobile enclosure includes the foldable floor panel of claim 19, the foldable floor panel of claim 19 being a floor of the sub-shelter assembly.
